(19) United States
(12) Patent Application Publication
(10) Pub. No.: US 2015/0220933 A1
(43) Pub. Date: Aug. 6, 2015

(54) METHODS AND SYSTEMS FOR MAKING SECURE ONLINE PAYMENTS

(71) Applicant: TENCENT TECHNOLOGY (SHENZHEN) COMPANY LIMITED, Shenzhen (CN)

(72) Inventor: MAOCAI LI, Shenzhen (CN)

(73) Assignee: TENCENT TECHNOLOGY (SHENZHEN) COMPANY LIMITED

(21) Appl. No.: 14/689,641

(22) Filed: Apr. 17, 2015

Related U.S. Application Data
(63) Continuation of application No. PCT/CN2014/084198, filed on Aug. 12, 2014.

(30) Foreign Application Priority Data
Oct. 30, 2013 (CN) 2013-10529357.4

(51) Int. Cl. G06Q 20/40

(52) U.S. Cl. CPC G06Q 20/40145

(57) ABSTRACT

A method and system for making secure online payments are disclosed. The method includes sending a request for making a payment to a payment platform, the request including a payment account number and a payment amount; receiving a prompt from the payment platform, the prompt requesting authentication data, the authentication data including fingerprint data and fingerprint collection terminal identification data; and sending requested authentication data to the payment platform. The method further includes receiving data indicating that the payment platform has made the requested payment. The method and system consistent with the present disclosure may authenticate a user before making a secure online payment and improve the security and user experience in making payments online.

### CROSS-REFERENCES TO RELATED APPLICATIONS

### Related Applications

This application is a continuation application of PCT Patent Application No. PCT/CN2014/084198, filed on Aug. 12, 2014, which is based upon and claims the benefit of priority from Chinese Patent Application No. 201310529357.4, filed on Oct. 30, 2013, the entire contents of both of which are incorporated herein by reference.

### FIELD OF THE INVENTION

The present disclosure relates to Internet technologies and, more particularly, to methods and systems for making secure payments online.

### BACKGROUND

With the development of Internet related technologies, users routinely use smartphones (e.g., Android phones, iOS phones), laptops, tablets, and other mobile devices (Mobile Internet Devices) as terminals to make payments online. Making online payment is efficient and well accepted by the user community. In many instances, when users use various devices to make payments online, they often need to enter passwords or PIN codes to complete the transactions. Manually inputting passwords or PIN codes may slow down the payment process, making the user experience tedious. Further, manually inputting passwords or PIN codes may cause security breaches and decrease the level of security during the transaction. Because the online secure credential management is an important aspect of computer technology dealing with online transaction applications, technical solutions are needed to solve and/or improve the issues associated with the existing credential management methods and systems.

The disclosed method and system are d to solve one or more problems set forth above and other problems.

### BRIEF SUMMARY OF THE DISCLOSURE

Embodiments consistent with the present disclosure provide a method, system, mobile device, or a server for making secure payments online. Embodiments consistent with the present disclosure enable instant messaging users to complete business transactions efficiently.

One aspect of the present disclosure provides a method for making secure online payments. The method includes sending a request for making a payment to a payment platform, the request including a payment account number and a payment amount; and receiving a prompt from the payment platform, the prompt requesting authentication data, the authentication data including fingerprint data and fingerprint collection terminal identification data. The method also includes sending the requested authentication data to the payment platform and receiving data indicating that the payment platform has made the requested payment.

Another aspect of the present disclosure provides another method for making secure online payments. The method includes receiving a request to a payment platform for making a payment, the request including a payment account number and a payment amount; and sending a prompt from the payment platform, the prompt requesting authentication data, the authentication data including fingerprint data and fingerprint collection terminal identification data. The method also includes receiving the requested authentication data from the user terminal; authenticating the request for making the payment; making the requested payment; and sending data indicating that the payment platform has made the requested payment.

Another aspect of the present disclosure provides a user terminal for making secure online payments. The terminal includes a sending unit that is configured to send a request for making a payment to a payment platform, the request including a payment account number and a payment amount, and a receiving unit that is configured to receive a prompt from the payment platform, the prompt requesting authentication data. The authentication data may include fingerprint data and fingerprint collection terminal identification data. Further, the sending unit may be further configured to send requested authentication data to the payment platform. The receiving unit may be further configured to receive data indicating that the payment platform has made the requested payment.

Another aspect of the present disclosure provides a payment platform for making secure online payments. The payment platform includes a receiving unit configured to receive a request for making a payment, the request including a payment account number and a payment amount; a sending unit configured to send a prompt from the payment platform, the prompt requesting authentication data, the authentication data including fingerprint data and fingerprint collection terminal identification data; and an operating unit configured to make the requested payment after authenticating the request. The receiving unit may be further configured to receive the requested authentication data. The sending unit may be further configured to send data indicating that the payment platform has made the requested payment.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of a method for making a secure payment online implemented by an exemplary embodiment consistent with the present disclosure;

FIG. 2 is an exemplary user interface for users to input fingerprint data implemented by an exemplary embodiment consistent with the present disclosure;

FIG. 3 is another user interface for confirming a payment implemented by an exemplary embodiment consistent with the present disclosure;

FIG. 4 is another flowchart of a method for making a secure payment online implemented by an exemplary embodiment consistent with the present disclosure;

FIG. 5 is another flowchart of a method for making a secure payment online implemented by an exemplary embodiment consistent with the present disclosure;

FIG. 6 is another flowchart of a method for making a secure payment online implemented by an exemplary embodiment consistent with the present disclosure;

FIG. 7 is another flowchart of a method for making a secure payment online implemented by an exemplary embodiment consistent with the present disclosure;

FIG. 8 is a block diagram of an exemplary user terminal consistent with the present disclosure;

FIG. 9 is another block diagram of an exemplary user terminal consistent with the present disclosure;

FIG. 10 is a block diagram of an exemplary server of a payment platform consistent with the present disclosure;

FIG. 11 is another block diagram of an exemplary server of a payment platform consistent with the present disclosure; and

FIG. 12 is an exemplary system for making secure online payments consistent with the present disclosure.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

Embodiments consistent with the present disclosure provide a system for making secure online payments. Embodiments of the present disclosure may simplify the online payment process, increase the speed and improve the security of online transactions.

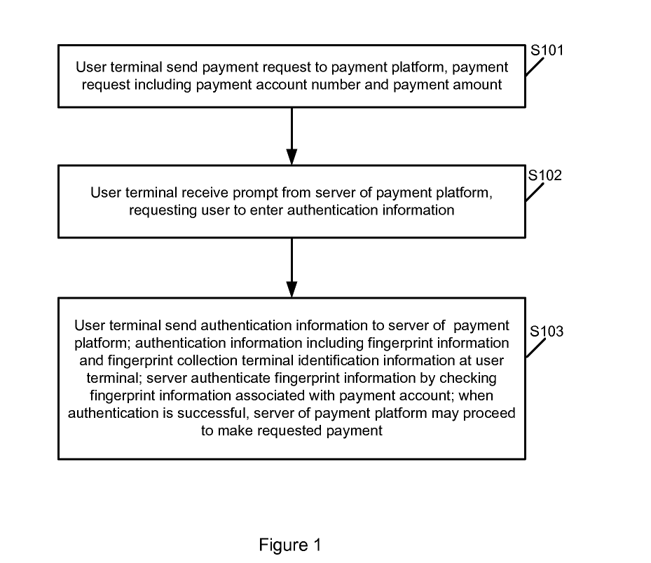

FIG. 1 shows a flow chart of a method for making secure online payments implemented by embodiments consistent with the present disclosure. The method shown in FIG. 1 may be described from the perspective of a user or a user terminal. The method shown in FIG. 1 includes steps S101-S103.

In step S101, a user terminal may send a payment request to a payment platform. The payment request may include information related to the payment account number and the payment amount. In the present disclosure, a payment account may refer to the account from which a user could draw a payment. The payment request may further include an account number associated with the payment request. In addition, in the present disclosure, a user terminal may be a smartphone (e.g., an Android phone or an iOS phone), a tablet, a laptop, or other Mobile Internet Devices (MIDs). A user terminal may also be a wearable computer or other mobile devices.

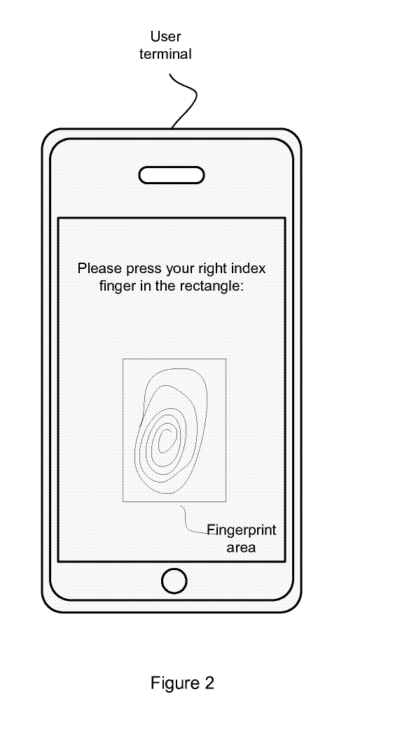

In step S102, the user terminal may receive a prompt from a server of the payment platform, prompting the user to enter authentication information. In the present disclosure, after the user terminal receives the prompt from the server of the payment platform, the user terminal may display the prompt through a user interface, requesting the user to enter authentication information such as fingerprint information. In one embodiment, as shown in FIG. 2, a user terminal may ask the user to enter fingerprint data on a region of a touch screen display.

In step S103, the user terminal may send the authentication information to the server of the payment platform. The authentication information may include the fingerprint collection terminal identification information of the user terminal and the fingerprint information entered by the user upon prompting by the user terminal. The server of the payment platform may process the fingerprint collection terminal identification information and the collected fingerprint information. The server may authenticate the resulting fingerprint information by checking the fingerprint information associated with the payment account number. When the authentication is successful, the server of the payment platform may proceed to make the requested payment.

The fingerprint collection terminal identification information may include data describing the type/model of the sensor used to collect the fingerprint information, or algorithms that may be needed to process the collected fingerprint data. Because various sensors and algorithms are used in the market to collect fingerprint information, the same user's fingerprint information may be collected and processed differently depending on which user terminal is used to collect the data. For example, a user may use user terminal A to register and submit the fingerprint information to be associated with his payment account. Later the user may use user terminal B to send a payment request to the server of the payment platform and submit his fingerprint information. In this example, user terminal B uses a different model of sensor and/or a different algorithm to collect and process the fingerprint information. As a result, the server of the payment platform may fail to authenticate the user through user terminal B if the sensor model and other fingerprint collection terminal identification data were not considered.

In embodiments consistent with the present disclosure, the user terminal may send the fingerprint collection terminal identification information when a user registers with the payment platform, associating the users fingerprint information and the corresponding fingerprint collection terminal identification information with the user's payment account. The fingerprint information and the fingerprint collection terminal identification information may be referred to as the authentication information.

In one embodiment, the payment platform may require a user to submit the authentication information from each user terminal from which he plans to initiate online payments. The server of the payment platform may then associate the authentication information from each user terminal to the user's payment account. If the user then submits a request for making a payment through one of the registered user terminals, the server of the payment platform may authenticate the user based on the authentication information associated with the payment account. If a first user terminal uses the same model of sensors and applies the same algorithm(s) to the collected fingerprint data as those of a second user terminal, for authentication purposes, the server of the payment platform may treat the first and the second terminals as the same user terminal.

Alternatively, the server of the payment platform may store the authentication information associated with only one user terminal, which may be the terminal the user first uses to register his information. The server of the payment platform may then apply various algorithms to the authentication information submitted from other user terminals so that it can properly compare the fingerprint information submitted from different user terminals (taking into account the sensor models, the algorithms used on fingerprint data, etc., of different terminals).

In one embodiment, before the user terminal executes step S101 shown in FIG. 1, it may first execute steps 11-22. In step 11, the user terminal may send a request for registration to the server of the payment platform. The request for registration may include a payment account number. That is, the user may request to register his authentication information from this “new” user terminal. In step 12, the user terminal may receive a prompt from the server of the payment platform, asking the user to enter fingerprint information. For example, as shown in FIG. 2, after the user terminal receives the prompt from the server of the payment platform, it may use the received prompt to request the user to enter his fingerprint information.

In step 13, the user terminal may send the authentication information, which may include the fingerprint collection terminal identification information and the fingerprint information entered by the user, to the server of the payment platform. The server of the payment platform may then associate the authentication information with the user's payment account and store the authentication information.

In step 14, the user terminal may receive a confirmation from the server of the payment platform that the registration is complete. By executing steps 11-14, the user terminal facilitates the user registration process. The server of the payment platform may receive authentication information, associate the authentication information with the user's payment account and store the authentication information. Step 14 may be an optional step.

In addition, after the user terminal sends the authentication information to the server of the payment platform, the user terminal may execute steps 21 and 22. In step 21, the user terminal may receive a request to confirm a payment request from the server of the payment platform. The confirmation request may include the information identifying a payment account number and a payment amount. In step 22, the user terminal may receive input from the user, confirming the payment request. The user terminal may send this confirmation to the server of the payment platform.

For example, in embodiments consistent with the present disclosure, as shown in

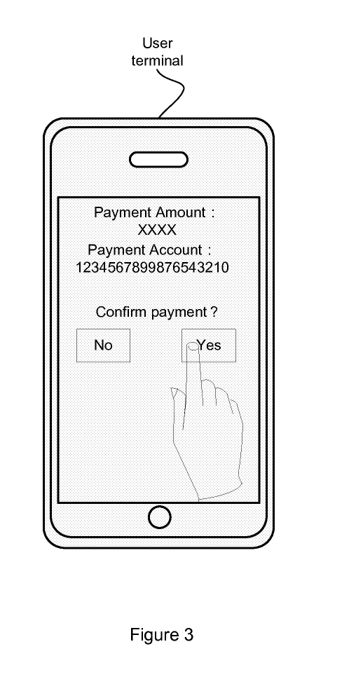

FIG. 3, the user terminal may send the confirmation for the payment request. The payment request may include the information identifying a payment account number “1234567899876543210” and a payment amount “XXXX” That is, the user may click the “Yes” (confirm) button on the user interface, which sends the confirmation to the user terminal. The user terminal may then send the confirmation to the server of the payment platform.

In one embodiment, as shown in FIG. 1, the user terminal may send the request for payment to the server of the payment platform in the manner described below. The user terminal may send a request for making online payment to a server of a trading platform. The server of the trading platform may send the request to the server of the payment platform. This may improve the security of the transaction. Alternatively, the user terminal may send the request for making an online payment to the server of the payment platform directly. This may support a point-to-point payment process.

Embodiments consistent with the present disclosure use fingerprint information submitted by a user to authenticate the user and make secure online payments from payment accounts. Embodiments consistent with the present disclosure improve the safety of online payment processes. Further, the method shown in FIG. 1 may be implemented by embodiments consistent with the present disclosure to simplify online payment processes and make these processes efficient.

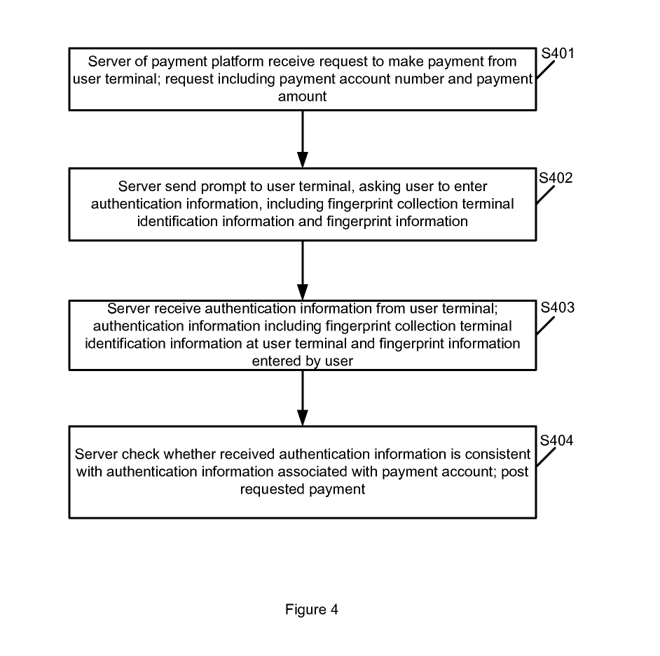

FIG. 4 shows another method for making secure online payments implemented by embodiments consistent with the present disclosure. The method shown in FIG. 4 is described from the perspective of the server of the payment platform. The method shown in FIG. 4 includes steps S401-S404. In step S401, the server of the payment platform may receive a request to make a payment from the user terminal. The request may include a payment account number and a payment amount. In step S402, the server may send a prompt to the user terminal, asking the user to enter authentication information, which may include fingerprint collection terminal identification information and fingerprint information. In step S403, the server of the payment platform may receive the authentication information from the user terminal. The authentication information may include the fingerprint collection terminal identification information at the user terminal and the fingerprint information entered by the user upon prompting by the user terminal. In step S404, the server may check whether the received authentication information is consistent with the authentication information associated with the payment account. If so, the server may post the requested payment.

The fingerprint collection terminal identification information may include data describing the model of the sensor for collecting the fingerprint information, or algorithms that may need to be applied to collected fingerprint data. Because various sensors and algorithms are used in the market to collect fingerprint information, the same user's fingerprint information may be collected and processed differently depending on which user terminal is used to input the data. For example, a user may use user terminal A to register and submit the fingerprint information to be associated with his payment account. Later the user may use user terminal B to send a payment request to the server of the payment platform and submit his fingerprint information. In this example, user terminal B uses a different model of sensor and/or a different algorithm to collect and process the fingerprint information. As a result, the server of the may fail to authenticate the user through user terminal B if the sensor model and other fingerprint collection terminal identification data were not considered.

In embodiments consistent with the present disclosure, the user terminal may send the fingerprint collection terminal identification information when a user registers with the payment platform, associated the users fingerprint information and the corresponding fingerprint collection terminal identification information with the user's payment account. The fingerprint information and the fingerprint collection terminal identification information may be referred to as the authentication information.

In one embodiment, the payment platform may require a user to submit the authentication information from each user terminal from which he plans to initiate online payments. The server of the payment platform may then associate the authentication information from each user terminal to the user's payment account. If the user then submits a request for making a payment online through one of these registered user terminals, the server of the payment platform may authenticate the user based on the authentication information associated with the payment account. If a first user terminal uses the same model of sensors and applies the same algorithm to the collected fingerprint data as those of a second user terminal, for authentication purposes, the server of the payment platform may treat the first and the second terminals as the same user terminal.

Alternatively, the server of the payment platform may store the authentication information associated with only one user terminal, which may be the terminal the user first uses to register his information. The server of the payment platform may then apply various algorithms to the authentication information submitted from other user terminals so that it can properly compare the fingerprint information submitted from different user terminals (taking into account the sensor models, the algorithms used on fingerprint data, etc. of different terminals).

In some embodiments, the server of the payment platform may make the requested payment by first deducting the payment amount from the payment account number (both included in the request for making payment), and then posting the payment amount to an identified receiving account.

In one embodiment, before the server of the payment platform executes step S401 shown in FIG. 4, it may first execute steps 31- 42. In step 31, the server of the payment platform may receive a request for registration to the server of the payment platform. The request for registration may include a payment account number. That is, the user is requesting to register his authentication information from this “new” user terminal. In step 32, the server of the payment platform may send a prompt from the server of the payment platform, asking the user to enter fingerprint information.

In step 33, the server of the payment platform may receive the authentication information, which may include the fingerprint collection terminal identification information and the fingerprint information entered by the user. The server of the payment platform may then associate the authentication information to the user's payment account and store the authentication information.

In step 34, the server of the payment platform may send a confirmation to the user terminal that the registration is complete. By executing steps 31-34, the server of the payment platform facilitates the user registration process. The server of the payment platform may receive authentication information, associate the authentication information to the user's payment account, and store the authentication information. Step 34 may be an optional step.

In addition, after the server of the payment platform receives the authentication information from the user terminal, the server of the payment platform may execute steps 41 and 42. In step 41, the server of the payment platform may send a request to confirm a payment request from the server of the payment platform. The confirmation request may include the information identifying a payment account number and a payment amount. In step 42, the server of the payment platform may receive input from the user terminal, confirming the payment request. By executing steps 41 and 42, the server of the payment platform may improve security of the online payment transactions.

In some embodiments, when executing the steps shown in FIG. 4, the server of the payment platform may receive the request for making a payment through a trading platform. Further, the method may include steps 51 and 52. In step 51, the server of the payment platform may receive data related to the past payments associated with the payment account number from the trading platform. Further, the server of the payment platform may receive a discount rate from the server of the trading platform. The discount rate may be based on the past payment amounts of payment account. In one example, the discount rate may be determined based on the total amount of the past payments. In step 52, the server of the payment platform may apply the discount to the payment amount identified in the request for payment, and make the discounted payment. By executing steps 51 and 52, the server of the payment platform rewards users for using the payment platform and encourages users to use the platform to make transactions.

Embodiments consistent with the present disclosure use fingerprint information submitted by a user to authenticate the user and make secure online payments from payment accounts. Embodiments consistent with the present disclosure improve the safety of online payment processes. Further, the method shown in FIG. 4 may be implemented by embodiments consistent with the present disclosure to simplify online payment processes and make these processes efficient.

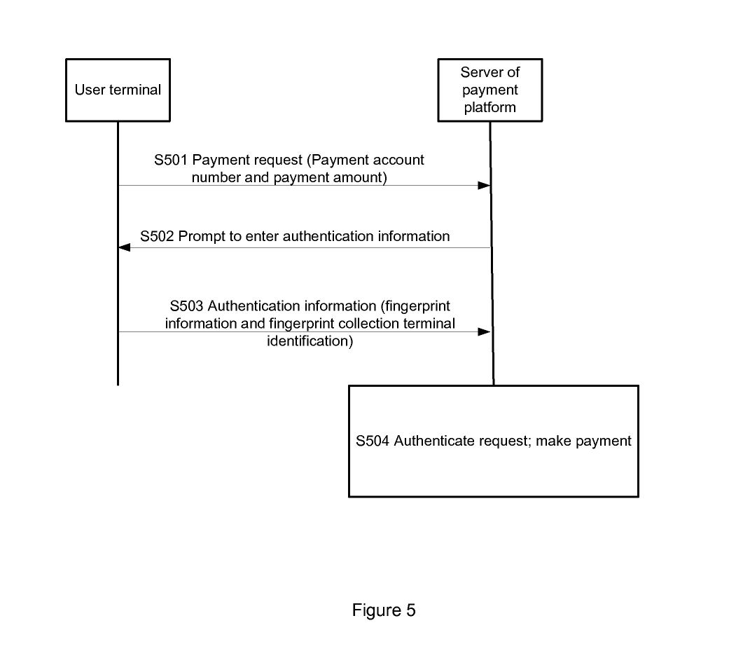

FIG. 5 shows another method for making secure online payments implemented by embodiments consistent with the present disclosure. The method shown in FIG. 5 may be described from the perspectives of both the user terminal and the server of the payment platform. The method shown in FIG. 5 includes steps S501-S504. In step S501, the user terminal may send the server of the payment platform a request to make a payment from the user terminal. The request may include a payment account number and a payment amount. In step S502, the server may send a prompt to the user terminal, asking the user to enter authentication information, which may include fingerprint collection terminal identification information and fingerprint information. In step S503, the user terminal may send the authentication information to the server of the payment platform. The authentication information may include the fingerprint collection terminal identification information at the user terminal and the fingerprint information entered by the user upon prompting by the user terminal. In step S504, the server may check whether the received authentication information is consistent with the authentication information associated with the payment account. If so, the server may post the requested payment.

Embodiments consistent with the present disclosure use fingerprint information submitted by a user to authenticate the user and make secure online payments from payment accounts. Embodiments consistent with the present disclosure improve the safety of online payment processes. Further, the method shown in FIG. 5 may be implemented by embodiments consistent with the present disclosure to simplify online payment processes and make these processes efficient.

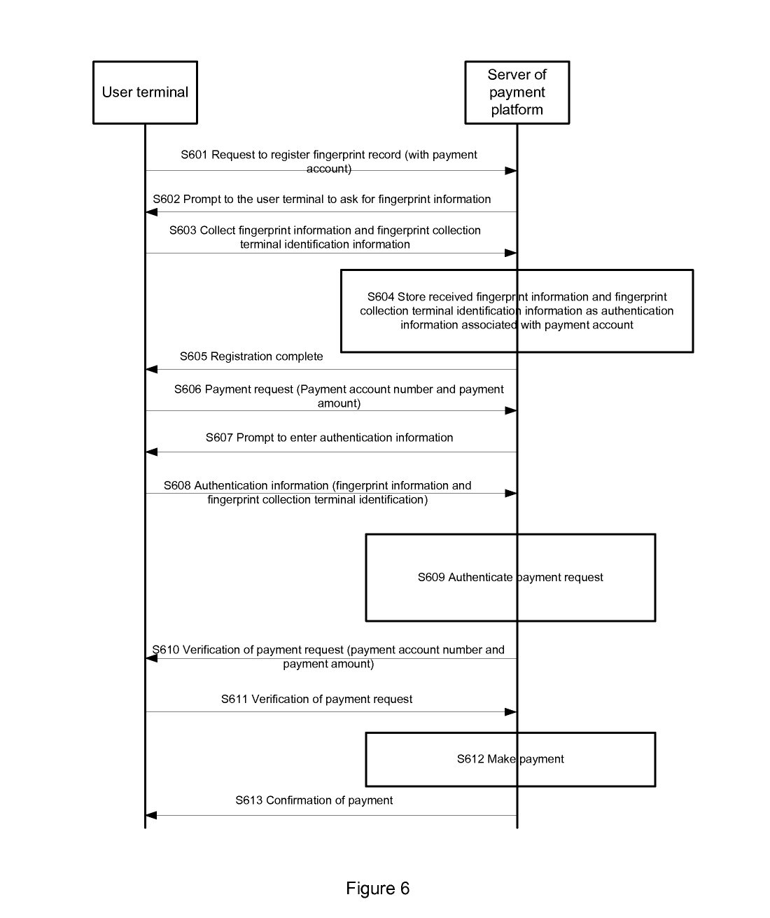

FIG. 6 shows another method for making secure online payments implemented by embodiments consistent with the present disclosure. The method shown in FIG. 6 may be described from the perspectives of both the user terminal and the server of the payment platform. The method shown in FIG. 6 includes steps S601-S613.

In step S601, the user terminal may send the server of the payment platform a request to register a fingerprint record. The request may include a payment account number. In step S602, the server may respond to the request, send a prompt to the user terminal to ask the user to enter fingerprint information. In step 603, the user terminal may receive the prompt from the server of the payment platform. The user terminal may receive fingerprint information from a user interface and send the received fingerprint information and the fingerprint collection terminal identification information to the server of the payment platform. In step S604, the server may store the received fingerprint information and the fingerprint collection terminal identification information as the authentication information associated with the payment account. In step S605, the server of the payment platform may send a message to the user terminal indicating that the fingerprint record registration process is complete.

In step S606, the user terminal may send the server of the payment platform a request to make a payment from the user terminal. The request may include the payment account number and a payment amount. In step S607, the server may send a prompt to the user terminal, asking the user to enter authentication information, which may include fingerprint collection terminal identification information and fingerprint information. In step S608, the user terminal may send the authentication information to the server of the payment platform. The authentication information may include the fingerprint collection terminal identification information of the user terminal and the fingerprint information entered by the user upon prompting by the user terminal. In step S609, the server may check whether the received authentication information is consistent with the authentication information associated with the payment account. If so, the server may execute step S610. In step S610, the server of the payment platform may send a confirmation to the user terminal to verify the payment request.

The confirmation may include the payment account and the payment amount. In step S611, the user terminal may receive the confirmation from the server of the payment platform. The user terminal may receive the confirmation from the user and send the confirmation results to the server of the payment platform. In step S612, the server of the payment platform may receive the confirmation results from the user terminal, and then make the requested payment. In step S613, the server of the payment platform may send a confirmation of payment to the user terminal.

Embodiments consistent with the present disclosure use fingerprint information submitted by a user to authenticate the user and make secure online payments from payment accounts. Embodiments consistent with the present disclosure improve the safety of online payment processes. Further, the method shown in FIG. 6 may be implemented by embodiments consistent with the present disclosure to simplify online payment processes and make these processes efficient.

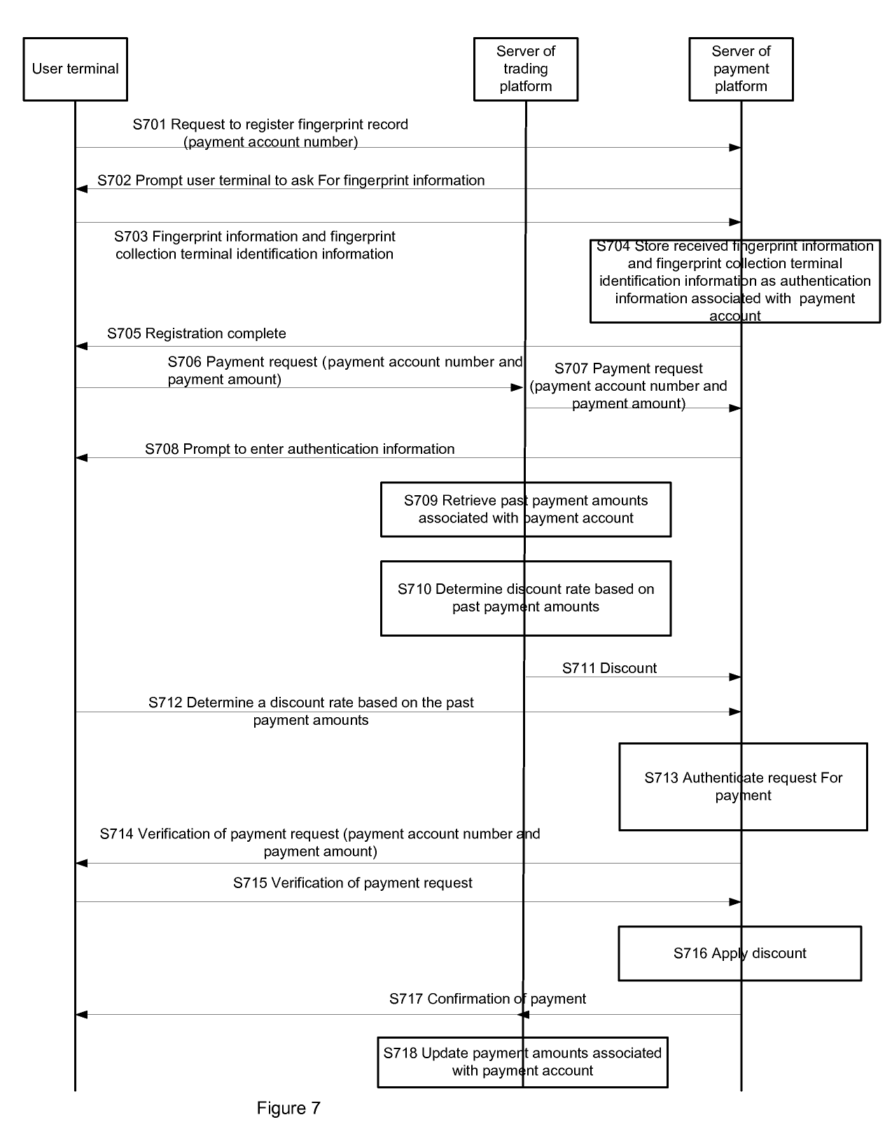

FIG. 7 shows another method for making secure online payments implemented by embodiments consistent with the present disclosure. The method shown in FIG. 7 may be described from the perspectives of the user terminal, the server of the trading platform, and the server of the payment platform. The method shown in FIG. 7 includes steps S701-S718.

In step S701, the user terminal may send the server of the payment platform a request to register a fingerprint record. The request may include a payment account number. In step S702, the server may respond to the request, send a prompt to the user terminal to ask the user to enter fingerprint information. In step 703, the user terminal may receive the prompt from the server of the payment platform. The user terminal may receive fingerprint information from a user interface and send the received fingerprint information and the fingerprint collection terminal identification information to the server of the payment platform. In step S704, the server may store the received fingerprint information and the fingerprint collection terminal identification information as the authentication information associated with the payment account. In step S705, the server of the payment platform may send a message to the user terminal indicating that the fingerprint record registration process is complete.

In step S706, the user terminal may send the server of the trading platform a request to make a payment from the user terminal. The request may include the payment account number and a payment amount. In step S707, server of the trading platform may send the request to make the payment to the server of the payment platform. In step S708, the server of the payment platform may receive the request to make a payment from the server of the trading platform. The server of the payment platform may then send a prompt to the user terminal, asking the user to enter authentication information. In step S709, the server of the trading platform may retrieve past payment amounts associated with the payment account. In step S710, the server of the trading platform may determine a discount rate based on the past payment amounts of the payment account. For example, the server of the trading platform may determine a discount percentage based on the total of the past payment amount (e.g., 5% discount if the total is more than $X; 10% discount if the total is more than $Y). In step S711, the server of the trading platform may send the determined discount rate to the server of the payment platform. In step S712, the user terminal may receive the prompt from the server of the payment platform, requesting authentication information. Upon receiving the authentication information from a user, the user terminal may send the authentication information to the server of the payment platform. The authentication information may include the fingerprint collection terminal identification information at the user terminal and the fingerprint information entered by the user upon prompting by the user terminal. In step S713, the server may check whether the received authentication information is consistent with the authentication information associated with the payment account. If so, the server may execute step S714. In step S714, the server of the payment platform may send a confirmation request to the user terminal to verify the payment request. The confirmation may include the payment account and the payment amount. In step S715, the user terminal may receive the confirmation from the server of the payment platform.

The user terminal may receive the confirmation from the user and send the confirmation results to the server of the payment platform. In step S716, the server of the payment platform may receive the confirmation results from the user terminal, apply the discount rate to the requested payment account, and post the discounted payment. In step S717, the server of the payment platform may send a confirmation of the discounted payment to the user terminal.

In the above example, steps S709-711 may be executed anywhere after step S707 and before step S716. In step S718, the server of the trading platform may update the past payment information associated with the payment account. For example, the server of the trading platform may track the total of past payments associated with the payment account. The server of the trading platform may thus add the payment made in step S716 to the previous total payment amount.

Embodiments consistent with the present disclosure use fingerprint information submitted by a user to authenticate the user and make secure online payments from payment accounts. Embodiments consistent with the present disclosure improve the safety of online payment processes. Further, the method shown in FIG. 7 may be implemented by embodiments consistent with the present disclosure to simplify online payment processes and make these processes efficient.

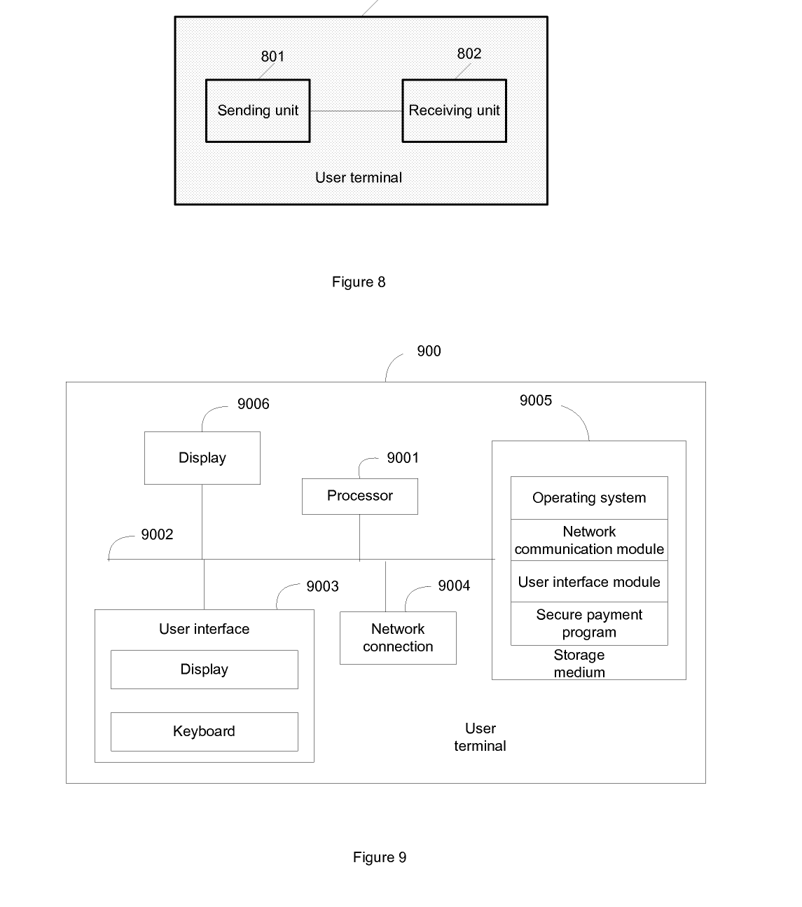

FIG. 8 is a schematic diagram of a user terminal consistent with the present disclosure. As shown in FIG. 8, the user terminal 800 may include a sending unit 801 and a receiving unit 802. The sending unit 801 may send the server of the payment platform a request to make a payment from the user terminal. The request may include a payment account number and a payment amount. In response, the server may send a prompt to the user terminal, asking the user to enter authentication information, which may include fingerprint collection terminal identification information and fingerprint information. The receiving unit 802 may receive the prompt from the server of the payment platform. The sending unit 801 may send the authentication information to the server of the payment platform. The authentication information may include the fingerprint collection terminal identification information at the user terminal and the fingerprint information entered by the user upon prompting by the user terminal. The server may check whether the received authentication information is consistent with the authentication information associated with the payment account. If so, the server may post the requested payment.

In some embodiments, before sending a request for making a payment, the sending unit 801 may also send a request for registration of fingerprint record to the server of the payment platform. The request may include a payment account number. The server may respond to the request, and send a prompt to the user terminal to ask the user to enter fingerprint information. The receiving unit 802 may receive the prompt from the server of the payment platform. The receiving unit 802 may further receive fingerprint information from a user interface. The sending unit 801 may send the received fingerprint information and the fingerprint collection terminal identification information to the server of the payment platform. The server may store the received fingerprint information and the fingerprint collection terminal identification information as the authentication information associated with the payment account. The server of the payment platform may send a message to the user terminal indicating that the fingerprint record registration process is complete.

The server of the payment platform may send a confirmation request to the user terminal to verify the payment request. The confirmation request may include the payment account number and the payment amount. The receiving unit 802 may receive the confirmation request from the server of the payment platform. The sending unit 801 may send the confirmation results to the server of the payment platform.

Embodiments consistent with the present disclosure use fingerprint information submitted by a user to authenticate the user and make secure online payments from a payment account. Embodiments consistent with the present disclosure improve the safety of online payment processes. Further, the method discussed in relation to FIG. 8 may be implemented by embodiments consistent with the present disclosure to simplify online payment processes and make these processes efficient.

FIG. 9 is another schematic diagram of a user terminal consistent with the present disclosure. As shown in FIG. 9, the server 900 of the user terminal may include a processor 9001, such as a CPU, a network connection 9004, a user interface 9003, storage medium 9005, and a bus 9002. Processor 9001 may include any appropriate processor or processors. Further, processor 9001 can include multiple cores for multi-thread or parallel processing. Storage medium 9005 may include memory modules, such as Read-only Memory (ROM), Random Access Memory (RAM), flash memory modules, and erasable and rewritable memory, and mass storages, such as CD-ROM, U-disk, and hard disk, etc. Storage medium 9005 may store computer programs for implementing various processes, when executed by processor 9001, including the operating system, communication program modules, and other application modules used to implement the system for making secure online payments consistent with the present disclosure. The network connection 9004 may connect to any appropriate type of communication networks, including the Internet, LAN (Local Area Network), or other types of computer networks or telecommunication networks, either wired or wireless. For example, the network connection 9004 may connect the online trading platform to the payment platform, so that a user may complete transactions seamlessly.

In FIG. 9, the network connection 9004 may be used to connect the sever of the trading platform and the server of the payment platform. The network connection 9004 may transfer data between the sever of the trading platform and the server of the payment platform. In addition, the processor 9001 may execute the application programs stored in the storage medium 9005 to implement secure online payment functions.

In some embodiments, before sending a request for making a payment, the network connection 9004 may also send a request for registration of fingerprint record to the server of the payment platform. The request may include a payment account number. The server may respond to the request, and send a prompt to the user terminal to ask the user to enter fingerprint information. The network connection 9004 may receive the prompt from the server of the payment platform. The network connection 9004 may further receive fingerprint information from a user interface. The network connection 9004 may send the received fingerprint information and the fingerprint collection terminal identification information to the server of the payment platform. The server may store the received fingerprint information and the fingerprint collection terminal identification information as the authentication information associated with the payment account. The server of the payment platform may send a message to the user terminal indicating that the fingerprint record registration process is complete.

In some embodiment, the network connection 9004 may send the server of the payment platform a request to make a payment from the user terminal. The request may include a payment account number and a payment amount. In response, the server may send a prompt to the user terminal, asking the user to enter authentication information, which may include fingerprint collection terminal identification information and fingerprint information. The network connection 9004 may receive the prompt from the server of the payment platform. The network connection 9004 may send the authentication information to the server of the payment platform. The authentication information may include the fingerprint collection terminal identification information at the user terminal and the fingerprint information entered by the user upon prompting by the user terminal. The server may check whether the received authentication information is consistent with the authentication information associated with the payment account. If so, the server may post the requested payment.

The server of the payment platform may send a confirmation request to the user terminal to verify the payment request. The confirmation request may include the payment account number and the payment amount. The network connection 9004 may receive the confirmation request from the server of the payment platform. The network connection 9004 may send the confirmation results to the server of the payment platform.

In the above examples, processor 9001 may also use the network connection 9004 to send the request for making online payment to the server of the trading platform. The server of the trading platform may then send the request for making online payment to the server of the payment platform.

Embodiments consistent with the present disclosure use fingerprint information submitted by a user to authenticate the user and make secure online payments from a payment account. Embodiments consistent with the present disclosure improve the safety of online payment processes. Further, the method discussed in relation to FIG. 9 may be implemented by embodiments consistent with the present disclosure to simplify online payment processes and make these processes efficient.

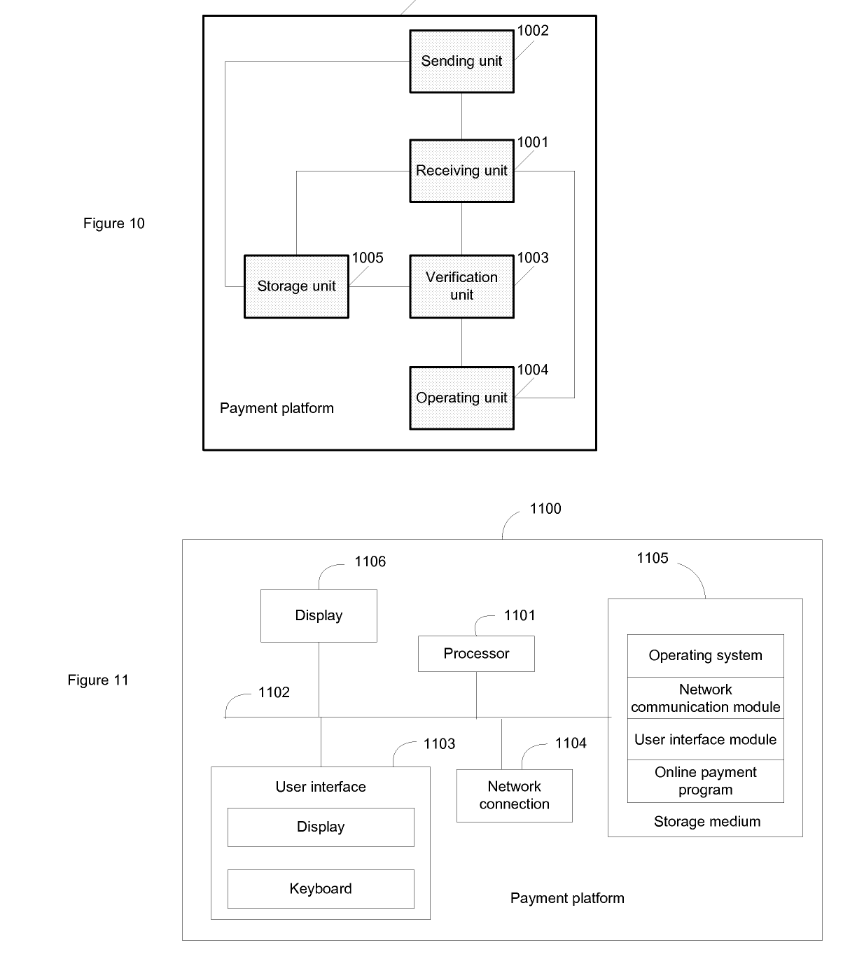

FIG. 10 shows a block diagram of a server of the payment platform consistent with the present disclosure. The server 1000 shown in FIG. 10 includes a receiving unit 1001, a sending unit 1002, a verification unit 1003, an operating unit 1004, and a storage unit 1005.

In some embodiments, the user terminal may send the server of the payment platform a request to make a payment from the user terminal. The request may include a payment account number and a payment amount. The receiving unit 1001 may receive the request to make a payment from the user terminal. The sending unit 1002 may send a prompt to the user terminal, asking the user to enter authentication information, which may include fingerprint collection terminal identification information and fingerprint information. The user terminal may send the authentication information to the server of the payment platform. The authentication information may include the fingerprint collection terminal identification information at the user terminal and the fingerprint information entered by the user upon prompting by the user terminal. The receiving unit 1001 may receive the authentication information. The verification unit 1003 may check whether the received authentication information is consistent with the authentication information associated with the payment account. If so, the operating unit 1004 may make the requested payment.

In some embodiments, before sending a request for making a payment, the user terminal may send the server of the payment platform a request to register a fingerprint record. The request may include a payment account number. The receiving unit 1001 may receive the request. The operating unit 1004 may respond to the received request. The sending unit 1002 may send a prompt to the user terminal to ask the user to enter fingerprint information. The user terminal may receive the prompt from the server of the payment platform. The user terminal may receive fingerprint information from a user interface and send the received fingerprint information and the fingerprint collection terminal identification information to the server of the payment platform. The storage unit 1005 may store the received fingerprint information and the fingerprint collection terminal identification information as the authentication information associated with the payment account. The sending unit 1001 may send a message to the user terminal indicating that the fingerprint record registration process is complete.

In some embodiments, the verification unit 1003 may further verify whether the received authentication information is consistent with the authentication information associated with the payment account, including whether the received fingerprint information is consistent with the fingerprint information associated with the payment account. Further, once the verification unit 1003 determines that the received authentication information is consistent with the authentication information associated with the payment account, the sending unit 1002 may send a confirmation request of the payment request to the user terminal. The confirmation request may include the payment account and payment amount requested. The user terminal may prompt the user to verify the payment request and send the results of verification to the server of the payment platform. The receiving unit 1001 may receive the verification results and trigger the operating unit 1004 to execute the steps to make the requested payment.

In some embodiment, the receiving unit 1001 may receive requests to make payments from user terminals. Each request may include a payment account and a requested payment amount. Further, the receiving unit 1001 may receive a discount rate from the server of the trading platform. The discount rate may be determined based on the past payments paid through the payment account. In this case, the operating unit 1004 may then may apply the discount rate to the requested payment amount, and then make the discounted payment.

Embodiments consistent with the present disclosure use fingerprint information submitted by a user to authenticate the user and make secure online payments from a payment account. Embodiments consistent with the present disclosure improve the safety of online payment processes. Further, the method shown in FIG. 10 may be implemented by embodiments consistent with the present disclosure to simplify online payment processes and make these processes efficient.

FIG. 11 is another schematic diagram of a server of a payment platform consistent with the present disclosure. As shown in FIG. 11, the server 1100 of the payment platform includes a processor 1101, such as a CPU, a network connection 1104, a user interface 1103, storage medium 1105, and a bus 1102. Processor 1101 may include any appropriate processor or processors. Further, processor 1101 can include multiple cores for multi-thread or parallel processing. Storage medium 1105 may include memory modules, such as Read-only Memory (ROM), Random Access Memory (RAM), flash memory modules, and erasable and rewritable memory, and mass storages, such as CD-ROM, U-disk, and hard disk, etc. Storage medium 1105 may store computer programs for implementing various processes, when executed by processor 1101, including the operating system, communication program modules, and other application modules used to implement the system for making secure online payment consistent with the present disclosure. The network connection 1104 may connect to any appropriate type of communication networks, including the Internet, LAN (Local Area Network), or other types of computer networks or telecommunication networks, either wired or wireless. For example, the network connection 1104 may connect the online trading platform to the payment platform, so that a user may complete transactions seamlessly.

As shown in FIG. 11, the network connection 1104 may connect the server of the payment platform to the user terminal. The network connection 1104 may transfer data between the sever of the trading platform and the user terminal. In addition, the processor 1101 may execute the application programs stored in the storage medium 1105 to implement secure online payment functions.

In some embodiments, the user terminal may send the server of the payment platform 1100 a request to make a payment. The request may include a payment account number and a payment amount. The network connection 1104 may receive the request to make a payment from the user terminal. The network connection 1104 may send a prompt to the user terminal, asking the user to enter authentication information, which may include fingerprint collection terminal identification information and fingerprint information. The user terminal may send the authentication information to the server of the payment platform. The authentication information may include the fingerprint collection terminal identification information at the user terminal and the fingerprint information entered by the user upon prompting by the user terminal. The network connection 1104 may receive the authentication information. The processor 1101 may check whether the received authentication information is consistent with the authentication information associated with the payment account. If so, the processor 1101 may make the requested payment.

In some embodiments, before sending a request for making a payment, the user terminal may send the server of the payment platform 1100 a request to register a fingerprint record. The request may include a payment account number. The network connection 1104 may receive the request. The server may respond to the received request. The network connection 1104 may send a prompt to the user terminal to ask the user to enter fingerprint information. The user terminal may receive the prompt from the server of the payment platform 1100. The user terminal may receive fingerprint information from a user interface and send the received fingerprint information and the fingerprint collection terminal identification information to the server of the payment platform 1100. The storage medium 1105 may store the received fingerprint information and the fingerprint collection terminal identification information as the authentication information associated with the payment account. The network connection 1104 may send a message to the user terminal indicating that the fingerprint record registration process is complete.

In some embodiments, the processor 1101 may further verify whether the received authentication information is consistent with the authentication information associated with the payment account, including whether the received fingerprint information is consistent with the fingerprint information associated with the payment account. Further, once the processor 1101 determines that the received authentication information is consistent with the authentication information associated with the payment account, the network connection 1104 may send a confirmation request of the payment request to the user terminal. The confirmation request including the payment account and payment amount requested. The user terminal may prompt the user to verify the payment request and send the results of verification to the server of the payment platform. The network connection 1104 may receive the verification results and trigger the online payment program stored in storage medium 1105 to execute the steps to make the requested payment.

In some embodiment, the network connection 1104 may receive requests to make payments from user terminals. Each request may include a payment account and a requested payment amount. Further, the network connection 1104 may receive a discount rate from the server of the trading platform. The discount rate may be determined based on the past payments paid through the payment account. In this case, the processor 1101 may then may apply the discount rate to the requested payment amount, and then make the discounted payment.

Embodiments consistent with the present disclosure use fingerprint information submitted by a user to authenticate the user and make secure online payments from a payment account. Embodiments consistent with the present disclosure improve the safety of online payment processes. Further, the method discussed in relation to FIG. 11 may be implemented by embodiments consistent with the present disclosure to simplify online payment processes and make these processes efficient.

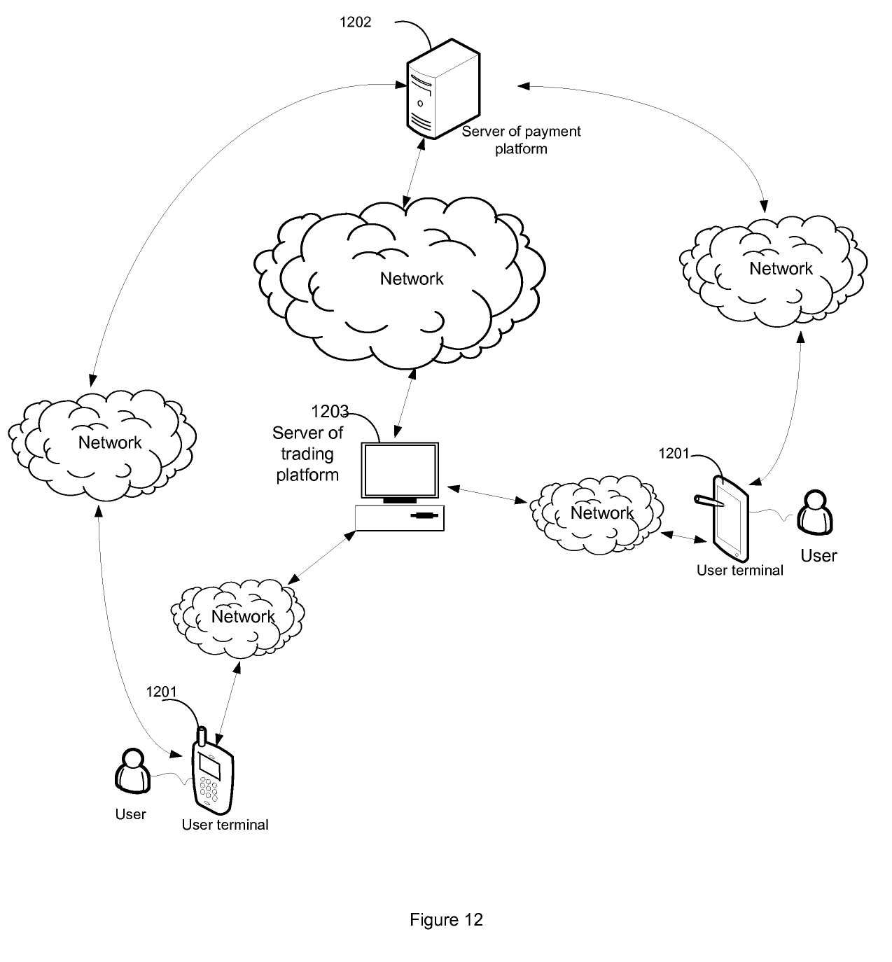

FIG. 12 is a block diagram of an exemplary system for making secure online payments consistent with the present disclosure. As shown in FIG. 12, the system for making secure online payment may include a user terminal 1201 and a server of the payment platform 1202. The user terminal 1201 may be connected to the server of the payment platform 1202. The user terminal 1201 may implement the functions described in relation to FIGS. 8 and 9 above. The server of the payment platform 1202 may implement the function described in relation to FIGS. 10 and 11 above.

In some embodiments, the user terminal 1201 may send the server of the payment platform 1202 a request to register a fingerprint record. The request may include a payment account number. The server 1202 may respond to the request, send a prompt to the user terminal 1201 to ask the user to enter fingerprint information. The user terminal 1201 may receive the prompt from the server of the payment platform 1202. The user terminal 1201 may receive fingerprint information from a user interface and send the received fingerprint information and the fingerprint collection terminal identification information to the server of the payment platform 1202. The server 1202 may store the received fingerprint information and the fingerprint collection terminal identification information as the authentication information associated with the payment account. The server 1202 of the payment platform may send a message to the user terminal indicating that the fingerprint record registration process is complete.

In some embodiments, the system for making secure online payment may further include a server of the trading platform 1203. The user terminal 1201 may send the server of the trading platform 1203 a request to make a payment from the user terminal. The request may include the payment account number and a payment amount. The server of the trading platform 1203 may send the request to make the payment to the server of the payment platform 1202. The server of the payment platform 1202 may receive the request to make a payment from the server of the trading platform 1203. The server of the payment platform 1202 may then send a prompt to the user terminal 1201, asking the user to enter authentication information. The server of the trading platform 1203 may retrieve past payments associated with the payment account. The server of the trading platform 1203 may determine a discount rate based on the past payment amount of the payment account. For example, the server of the trading platform 1203 may determine a discount percentage based on the total of the past payment amount (e.g., 5% discount if the total is more than $X; 10% discount if the total is more than $Y). The server of the trading platform 1203 may send the determined discount rate to the server of the payment platform 1202.

The user terminal 1201 may receive the prompt from the server of the payment platform 1202, requesting authentication information. Upon receiving the authentication information from a user, the user terminal 1201 may send the authentication information to the server of the payment platform 1202. The authentication information may include the fingerprint collection terminal identification information of the user terminal 1201 and the fingerprint information entered by the user upon prompting by the user terminal 1201. The server 1202 may check whether the received authentication information is consistent with the authentication information associated with the payment account. If so, the server 1202 may execute the following steps. First, the server of the payment platform 1202 may send a confirmation request to the user terminal 1201 to verify the payment request. The confirmation request may include the payment account and the payment amount. Then, the user terminal 1201 may receive the confirmation request from the server of the payment platform 1202. The user terminal 1201 may receive the confirmation results from the user and send the confirmation results to the server of the payment platform 1202. Further, the server of the payment platform 1202 may receive the confirmation results from the user terminal 1201, apply the discount rate (from server 1203) to the requested payment account, and post the discounted payment. Finally, the server of the payment platform 1202 may send a confirmation of the discounted payment to the user terminal 1201. In addition, the server of the trading platform 1203 may update the past payment information associated with the payment account. For example, the server of the trading platform 1203 may track the total of past payments associated with the payment account. The server of the trading platform 1203 may thus add the payment most recently made to the previous total amount.

Embodiments consistent with the present disclosure use fingerprint information submitted by a user to authenticate the user and make secure online payments from a payment account. Embodiments consistent with the present disclosure improve the safety of online payment processes. Further, the method discussed in relation to FIG. 12 may be implemented by embodiments consistent with the present disclosure to simplify online payment processes and make these processes efficient.

Consistent with embodiments of the present disclosure, one or more non-transitory storage medium storing a computer program are provided to implement the system and method for making secure online payments. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various systems for online transactions may be implemented. For example, users in an instant messaging session may use an online secure payment system to purchase services and/or products. The online secure payment system may have a user interface through the instant messaging session. The device hosting the instant messaging session may include a camera, a touch pad, or other communication modules.

The online secure payment system may collect biometric data, such as facial data, fingerprint data, iris image data as well as data descriptive of specific user terminals. The online secure payment system may store the biometric data together with data descriptive of one or more user terminals (i.e., authentication data) and associate the authentication data with one or more payment accounts.

The secure online payment system may then authenticate the user by comparing the collected authentication data to stored authentication data associated with a payment account. Once the user/request is authenticated, the system may prompt the user to enter data for an online transaction. The online transaction may be purchasing one or more products or services, submitting documents, making payments, etc. The secure online payment system may include a payment platform or other platforms, such as an information-sharing portal, a social network site, etc. An exemplary instant messaging system may be Tencent's WeChat system. The instant messaging session may be hosted on any type of computing devices, including laptops, tablets, smartphones, etc.

By authenticating users and enabling secure payments online, the system for making secure online payment consistent with the present disclosure provides users with a secure online transaction environment.

What is claimed is:

1. A method for making secure online payments, comprising:
sending a request for making a payment to a payment platform, the request including a payment account number and a payment amount;
receiving a prompt from the payment platform, the prompt requesting authentication data, the authentication data including fingerprint data and fingerprint collection terminal identification data;
sending the requested authentication data to the payment platform; and
receiving data indicating that the payment platform has made the requested payment.

2. The method according to claim 1, further comprising:
sending a request to the payment platform to register a fingerprint record, the request including a payment account number associated with the fingerprint record;
receiving a response from the payment platform, prompting a user to enter the fingerprint record, the fingerprint record including finger print data and fingerprint collection terminal identification data;
sending the fingerprint record to be registered to the payment platform; and
receiving a confirmation that the payment platform has completed the registration of the fingerprint record.

3. The method according to claim 2, further comprising:
receiving a confirmation request verifying the request for making the payment, the confirmation request including the payment account number and the payment amount ; and
sending a confirmation message to the payment platform to confirm the information provided in the confirmation request.

4. The method according to claim 2, further comprising:
sending the request for the payment to a trading platform; and
receiving data indicating that the payment platform has made the requested payment after applying a discount determined by the trading platform.

5. The method according to claim 2, wherein the fingerprint collection terminal identification data include an identification of a fingerprint collection terminal or an algorithm used to process fingerprint data.

6. A method for making secure online payments, comprising:
receiving, at a payment platform, a request for making a payment from a user terminal, the request including a payment account number and a payment amount;
sending a prompt from the payment platform, the prompt requesting authentication data, the authentication data including fingerprint data and fingerprint collection terminal identification data;
receiving the requested authentication data from the user terminal;
authenticating the request for making the payment;
making the requested payment; and
sending data indicating that the payment platform has made the requested payment.

7. The method according to claim 6, further comprising:
receiving a request to register a fingerprint record to the payment platform, the request including a payment account number associated with the fingerprint record;
sending a response to the request, prompting a user to enter the fingerprint record, the fingerprint record including finger print data and fingerprint collection terminal identification data;
receiving the fingerprint record to be registered from the user terminal; and
sending a confirmation that the payment platform has completed the registration of the fingerprint record.

8. The method according to claim 7, further comprising:
sending a confirmation request verifying the request for making a payment, the confirmation request including the payment account number and the payment amount ; and
receiving a confirmation message from the user terminal to confirm the information provided in the confirmation request.

9. The method according to claim 7, further comprising:
receiving a discount from a trading platform, the discount being based on past payments associated with the payment account number;
applying the discount determined by the trading platform to the request payment; and
making the payment after applying the discount.

10. The method according to claim 7, wherein the fingerprint collection terminal identification data include an identification of a fingerprint collection terminal or an algorithm used to process fingerprint data.

11. A user terminal for making secure online payments, comprising:
a sending unit configured to send a request for making a payment to a payment platform, the request including a payment account number and a payment amount;
a receiving unit configure to receive a prompt from the payment platform, the prompt requesting authentication data, the authentication data including fingerprint data and fingerprint collection terminal identification data; and
wherein the sending unit is further configured to send requested authentication data to the payment platform; and the receiving unit is further configured to receive data indicating that the payment platform has made the requested payment.

12. The user terminal according to claim 11, wherein the sending unit is further configured to send a request to register a fingerprint record to the payment platform, the request including a payment account number associated with the fingerprint record; the receiving unit is further configured to receive a response from the payment platform, prompting a user to enter the fingerprint record, the fingerprint record including finger print data and fingerprint collection terminal identification data; the sending unit is further configured to send the fingerprint record to be registered to the payment platform; and the receiving unit is further configured to receive a confirmation that the payment platform has completed the registration of the fingerprint record.

13. The user terminal according to claim 12, wherein the receiving unit is further configured to receive a confirmation request verifying the request for making a payment, the confirmation request including the payment account number and the payment amount; and the sending unit is further configured to send a confirmation message to the payment platform to confirm the information provided in the confirmation request.

14. The user terminal according to claim 12, wherein the sending unit is configured to send the request for payment to a trading platform; and the receiving unit is configured to receive data indicating that the payment platform has made the requested payment after applying a discount determined by the trading platform.

15. The user terminal according to claim 12, wherein the fingerprint collection terminal identification data include an identification of a fingerprint collection terminal or an algorithm used to process fingerprint data.

16. A payment platform for making secure online payments, comprising:
a receiving unit configured to receive a request for making a payment from a user terminal, the request including a payment account number and a payment amount;
a sending unit configured to send a prompt to the user terminal, the prompt requesting authentication data, the authentication data including fingerprint data and fingerprint collection terminal identification data;
an operating unit configured to make the requested payment after authenticating the request; and
wherein the receiving unit is further configured to receive requested authentication data from the user terminal; and the sending unit is further configured to send data indicating that the payment platform has made the requested payment.

17. The payment platform according to claim 16, wherein the receiving unit is further configured to receive a request to register a fingerprint record from the user terminal, the request including a payment account number associated with the fingerprint record; the sending unit is further configured to send a response to the request, prompting a user to enter the fingerprint record, the fingerprint record including finger print data and fingerprint collection terminal identification data; the receiving unit is further configured to receive the fingerprint record to be registered from the user terminal; and the sending unit is further configured to send a confirmation that the payment platform has completed the registration of the fingerprint record.

18. The payment platform according to claim 17, wherein the sending unit is further configured to send a confirmation request verifying the request for making a payment, the confirmation request including the payment account number and the payment amount; and the receiving unit is further configured to receive a confirmation message to the payment platform to confirm the information provided in the confirmation request.

19. The payment platform according to claim 17, wherein the receiving unit is further configured to receive a discount from a trading platform, the discount being based on past payments associated with the payment account number; and the operating unit is further configured to apply the discount determined by the trading platform to the request payment and make the payment after applying the discount.

20. The payment platform according to claim 17, wherein the fingerprint collection terminal identification data include an identification of a fingerprint collection terminal or an algorithm used to process fingerprint data.
